(19) United States
(12) Patent Application Publication
(10) Pub. No.: US 2012/0152680 A1
(43) Pub. Date: Jun. 21, 2012

(54) MODIFIED FRICTION MEMBER FOR BALANCED UNIT LOADING

(75) Inventors: Jeremy Vanni, Sterling, OH (US); Brian C. Zaugg, Millersburg, OH (US)

(73) Assignee: SCHAEFFLER TECHNOLOGIES GMBH & CO. KG, Herzogenaurach (DE)

(21) Appl. No.: 13/312,262

(22) Filed: Dec. 6, 2011

Related U.S. Application Data
(60) Provisional application No. 61/423,715, filed on Dec. 16, 2010.

(51) Int. Cl. F16D 25/0635; F16D 13/38

(52) U.S. Cl. 192/3.29; 192/66.3; 192/3.33

(57) ABSTRACT

A clutch including a first member having a first friction surface, wherein the first friction surface has an inner diameter and an outer diameter, a second member having a second friction surface, wherein at least one of the first or second members is moveable axially for engaging the first friction surface with the second friction surface for closing the clutch, wherein the first member is thinner in a first area approximately radially aligned with the first inner diameter, the first outer diameter, or both, than in a second area radially aligned with a portion of the first friction surface generally located radially between the first inner diameter and the first outer diameter.

### CROSS-REFERENCE TO RELATED APPLICATIONS

This application claims the benefit under 35 U.S.C. §119(e) of U.S. Provisional Application No. 61/423,715 filed Dec. 16, 2010, which application is incorporated herein by reference.

### FIELD OF THE INVENTION

The invention broadly relates to frictional engagement devices, more specifically to clutches, and even more particularly to a clutch having a modified friction member for a balanced unit load on a friction surface.

### BACKGROUND OF THE INVENTION

Clutches are well known in the art for coupling two members, such as rotating plates, shafts, etc., together. Typically, clutches include friction surfaces made of specifically chosen materials to set various properties of the clutch, such as the coefficient of friction, longevity, compression strength, deformability, heat resistance, etc. The friction surfaces are generally arranged as rings having an inner diameter and an outer diameter. When closing the clutch, pressure on one side of an engagement member for the clutch causes a load on one or more friction surfaces of the clutch. This creates a pressure distribution along the friction surface, between the inner and outer diameter of the friction surface. This pressure distribution on the friction surface is also referred to as unit pressure or unit loading. High localized pressure on a friction surface could result in deformation of the surface. Further, the pressure distribution corresponds to the amount of heat generated in the friction surface, particularly during slippage of the clutch, with increased unit loading indicating larger amounts of heat. Even in wet-running clutches, the heat can become high enough to damage the friction surfaces of the clutch. The unit loading is often such that there is a higher pressure near the inner and outer diameters of the friction surface in comparison to the middle of the friction surface, between the inner and outer diameters. Thus, it is desired to create a more even unit loading so that the heat and pressure is balanced across the friction surface in order to minimize damage to the friction surface.

Torque converters, for example, often include wet running clutches that comprise paper based friction materials arranged between rotating metal components, such as a cover and piston plate, where the friction material forms frictional surfaces for engagement, for example, with the surfaces of the piston and/or cover. Even though they are wet-running, this paper based friction material can become scorched, burned, or permanently deformed if the heat and/or pressure becomes too high in certain areas of the surface of the friction material, such as near the inner and outer diameters, due to uneven unit loading across the friction surfaces of the clutch.

### BRIEF SUMMARY OF THE INVENTION

The present invention broadly comprises a clutch including a first member having a first friction surface, wherein the first friction surface has an inner diameter and an outer diameter, a second member having a second friction surface, wherein at least one of the first or second members is moveable axially for engaging the first friction surface with the second friction surface for closing the clutch, wherein the first member is thinner in a first area approximately radially aligned with the first inner diameter, the first outer diameter, or both, than in a second area radially aligned with a portion of the first friction surface generally located radially between the first inner diameter and the first outer diameter.

In one embodiment, the first friction surface includes an axial bulge in the portion of the friction surface between the first inner diameter and the first outer diameter. In one embodiment, the axial bulge is defined by an arc having a radius at least one order of magnitude larger than a radial distance between the inner diameter and the outer diameter. In one embodiment, the radius equals approximately between 500 mm and 3000 mm. In another embodiment, the radial distance between the inner and outer diameters of the first friction surface equals approximately between 10 mm and 30 mm. In a further embodiment, the radius equals 2000 mm and the radial distance equals 30 mm.

In another embodiment, the clutch recited in claim 1, wherein the first member includes at least one relief cut located approximately radially aligned with the inner diameter, the outer diameter, or both, of the first friction surface. In one embodiment, the at least one relief cut is formed in a second surface of the first member, the second surface being arranged axially opposite to the first friction surface.

The current invention also broadly comprises a torque converter including the clutch described above. In one embodiment, the torque converter further comprises a piston operatively arranged to move axially for engaging the clutch in response to a pressure applied to the piston. In one embodiment, the piston includes a tapered end for engaging the clutch. In one embodiment, the clutch is a lock-up clutch for mechanically connecting a vibration damper of the torque converter to a cover of the torque converter. In one embodiment, a plate from the vibration damper includes third and fourth friction surfaces for engaging the first and second friction surfaces of the first and second members, respectively.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a cross-sectional view of a torque converter having a clutch with a modified friction member;

FIG. 2 is a cross-sectional view of a clutch having a modified friction member according to a first embodiment of the current invention;

FIG. 3 is a cross-sectional view of a clutch having a modified friction member according to a second embodiment of the current invention;

FIG. 4 is a graph illustrating a performance of a state of the art clutch having a tapered engagement member;

FIG. 5 is a graph illustrating a performance of a clutch resembling the embodiment of FIG. 2; and,

FIG. 6 is a graph illustrating a performance of a clutch resembling the embodiment of FIG. 3.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

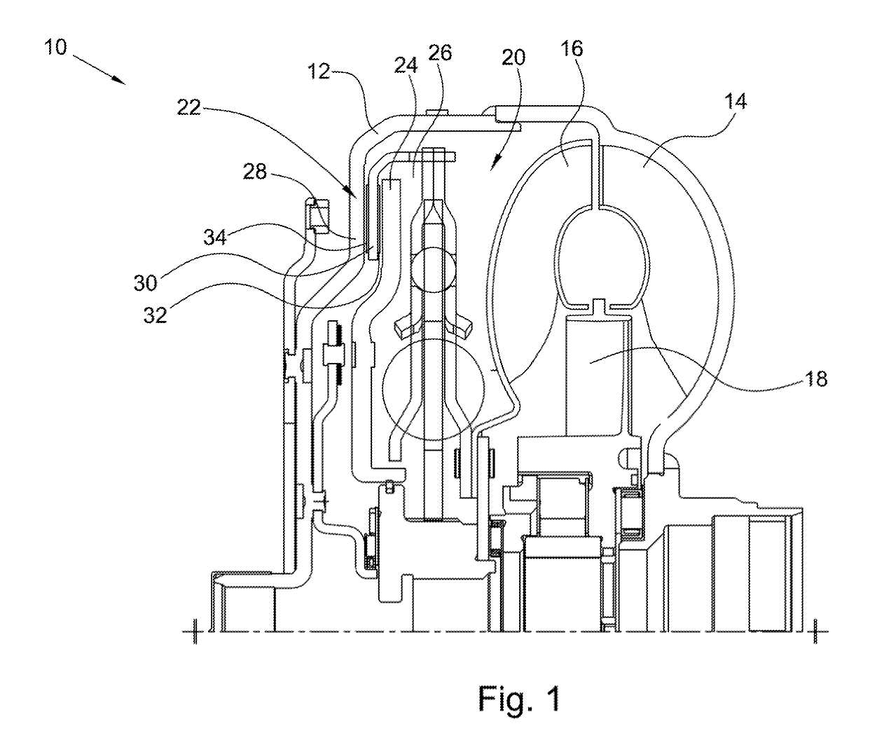

Unless defined otherwise, all technical and scientific terms used herein have the same meaning as commonly understood to one of ordinary skill in the art to which this invention belongs. Any reference to axial or radial properties or distances is with respect to the axis of rotation shown along the bottom of FIG. 1, unless otherwise specified. “Friction surface”, “engagement surface”, or “contact surface” may be used interchangeably herein to refer to the surfaces of the clutch that engage or contact together to close the clutch. Although any methods, devices or materials similar or equivalent to those described herein can be used in the practice or testing of the invention, the preferred methods, devices, and materials are now described.

Referring now to the figures, FIG. 1 shows torque converter 10 arranged, for example, with cover 12 connected to an engine or other torsional input (not shown), the torque converter also having impeller 14, turbine 16, stator 18, and vibration damper 20 for transferring torque hydraulically between the engine and an input shaft for a transmission (not shown). These components are shown for illustrative purposes only, and could be replaced by any type or style of cover, impeller, turbine, stator, and/or vibration damper known in the art, and in some embodiments, some or all of these components may not even be included.

In the particular embodiment shown in FIG. 1, clutch 22 is installed between vibration damper 20 and cover 12 as a lock-up clutch for mechanically connecting the vibration damper to the torsional input (e.g., engine), bypassing the hydraulic torque transferring devices (e.g., the impeller, turbine, and stator). Piston 24 is included to engage and disengage clutch 22, based on an axial position of the piston, namely, the piston is moveable between a closed position and an open position. For example, by pressurizing chamber 26 on a first axial side of piston 24, a pressure is applied to the piston for moving the piston axially toward clutch 22 for engaging the clutch between member 28 of cover 12 and piston 24.

That is, clutch plate 30, which is connected to damper 20, is located between piston 24 and portion 28 of the cover, with the clutch plate including friction rings 32 and 34.

The friction rings are, for example, paper based friction material bonded to clutch plate 30. Thus, friction rings 32 and 34 are used to form friction surfaces for plate 30, specifically surfaces 33 and 35 are formed on rings 32 and 34, respectively. For example, the friction rings may be used instead of engaging the piston directly against the clutch plate or cover, in order for a user to select materials which enable desired performance of the clutch, such as for setting the amount of slippage in the clutch with respect to different pressures applied to piston 24, the coefficient of friction between the piston or cover and clutch plate 30, etc.

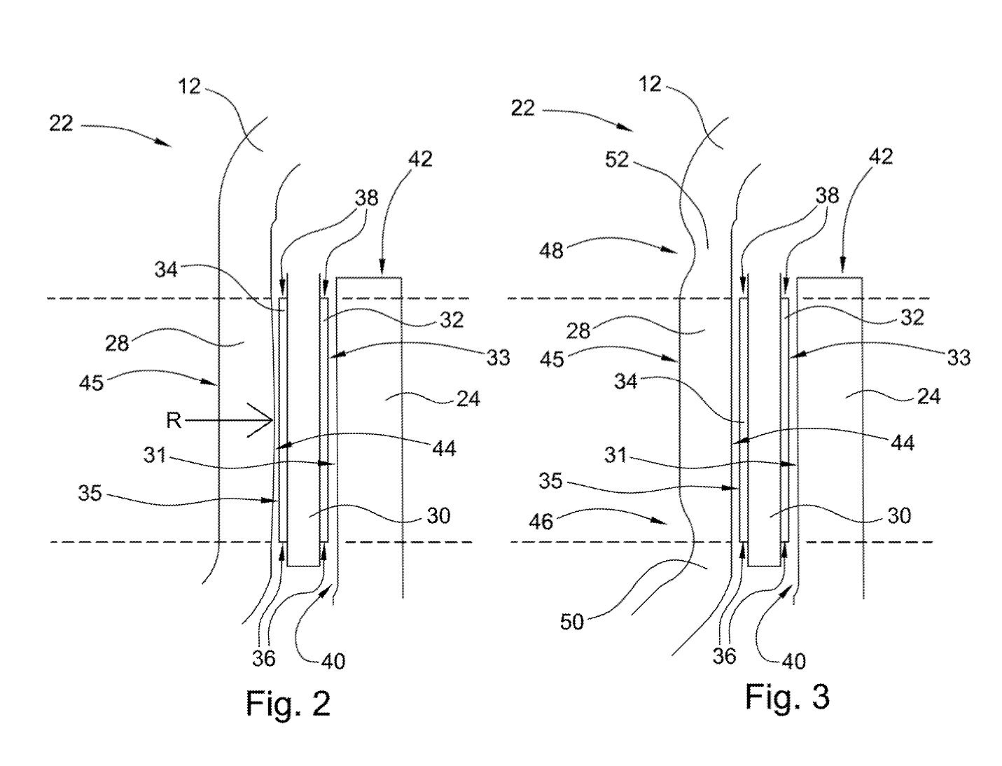

As shown in FIG. 2, friction rings 32 and 34 are each defined between inner diameter 36 (“ID” 36) and outer diameter 38 (“OD” 38). The inner and outer diameters define the extents of the friction and/or contact surfaces of the piston, cover, and friction rings of the clutch plate. Dashed lines are drawn extending axially from the inner and outer diameters of the friction rings to generally identify the portions of piston 24 and cover 12 that are radially aligned with, and engage against, the friction surfaces of the friction rings. That is, by radially aligned, it is meant the portion of each of member 28 and piston 24 that is located at a radial distance (with respect to the axis of rotation of torque converter 10) between ID 36 and OD 38. As used herein, “friction surface” or “contact surface” refers to the portion of the elements of clutch 22 that contact together for engagement of the clutch, and thus, the friction surfaces are defined essentially between inner and outer diameters represented by the set of dashed lines in FIGS. 2 and 3.

During engagement of the clutch, pressure, such as from pressurizing chamber 26, is applied to piston 24 to axially move the piston toward portion 28 such that contact surface 31 of piston 24 is thrust against friction surface 33 of friction ring 32 of clutch plate 30, which causes friction surface 35 of friction ring 34, which is commonly bonded to clutch plate 30 with friction ring 32, to be thrust against contact surface 44 of member 28. By releasing the pressure exerted on the piston, such as by depressurizing chamber 26, the piston can return to its open position, causing friction surfaces 33 and 35 of friction rings 32 and 34, respectively, to disengage from contact surfaces 31 and 44 of piston 24 and portion 28 of cover 12, respectively. In this way, clutch 22 can be used to mechanically connect or disconnect damper 20 and cover 12.

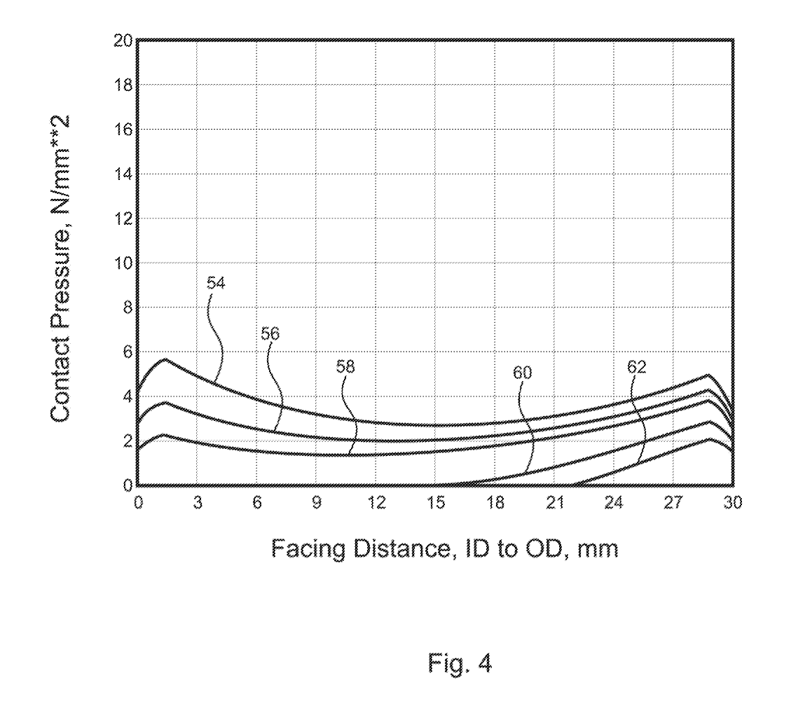

Piston 24 is tapered, including tapered cut 40 in the piston proximate to the inner diameter of friction material 32, such that the axial width of the piston increases from cut 40 to end 42 of the piston. Such tapered engagement surfaces have been found to improve engagement of a clutch, but may result in a significant increase of heat in the friction surface proximate to the outer diameter of the friction material. For example, FIG. 4 shows a plot of the performance of a state of the art clutch having a tapered piston, plotting the facing distance (from the inner diameter to the outer diameter) with respect to the contact pressure. Each of lines 54, 56, 58, 60, and 62 relates to a different pressure applied to piston 24 for closing clutch 22 (“apply pressure”). For example, the apply pressures are approximately 160 PSI, 120 PSI, 90 PSI, 30 PSI, and 15 PSI for lines 54, 56, 58, 60, and 62, respectively. Thus, it can be seen for example with respect to lines 60 and 62, that if low pressures are applied to the piston, the clutch is only beginning to engage, and the slip energy is borne entirely by the outer portion of the friction surface (i.e., the right side of the graph) due to the tapered piston. Even at higher apply pressures, there remains a peak in unit loading in the area near the outer diameter of the friction surface. At higher apply pressures, a second peak is formed proximate the inner diameter, for example, due at least partially to a flexing of the piston that occurs while closing the clutch. There is accordingly more likely to be damage near the inner and outer diameters of the friction surfaces of the clutch, where the unit loading is greatest.

Member 28 includes friction surface 44, which engages against friction surface 35 of clutch plate 30 (formed by friction ring 34). The portion of friction surface 44 radially aligned between the inner and outer diameters (that is, the portion of surface 44 that lies between the pair of dashed lines identifying the inner and outer diameters) is bulged, domed, or curved in the axial direction. That is, the bulge, dome, or curvature results in member 28 being axially thinner where radially aligned with the inner and/or outer diameters, and thicker at the portion of member 28 located between the inner and outer diameters. When used herein, the “thickness” or “axial thickness” of the cover is generally defined between surface 44 and opposite surface 45. The bulge, dome, or curvature in surface 44 is defined by an arc having a radius, which is generally indicated by the arrow labeled R. For simplicity, both the radius forming the arc, and the arc itself, may be generally referred to with the label R. It should be appreciated that the center of the arc forming surface 44 is not shown in FIG. 2 because the center is located well out of the extents of FIG. 2. For example, in one embodiment, the radial distance between inner diameter 36 and outer diameter 38 is 30 mm and the radius R is equal to approximately 2000 mm. In some embodiments, the radial distance between the ID and OD could range between approximately 10 mm and 30 mm, while radius R could range between approximately 500 mm and 3000 mm. Thus, it should be appreciated that the curvature of surface 44 in this embodiment is approximately at least one order of magnitude larger than the distance between the ID and OD, and up to approximately two or three orders of magnitude larger. That is, the radius R has been found to work suitably when in the range of ten to several hundred times larger than the distance between the ID and OD, although it should be appreciated that other ratios may work sufficiently well in other embodiments.

Similar to the embodiment of FIG. 2, clutch 22 in FIG. 3 includes a feature that makes member 28 axially thicker in the area between the inner and outer diameters of the friction surfaces than in the areas radially aligned with the friction surfaces. Specifically, in FIG. 3, member 28 includes relief cuts 46 and 48 in surface 45 for forming thinner sections 50 and 52 in member 28. As can be seen, thin section 50 is approximately radially aligned with inner diameter 36, while section 52 is approximately radially aligned with outer diameter 38. For example, the relief cuts enable portion 28 to flex slightly more in the areas corresponding radially to the inner and outer diameter of the friction surface, for relieving the load on the friction surfaces proximate the inner and outer diameters, and therefore balancing the load more evenly across friction surface 34.

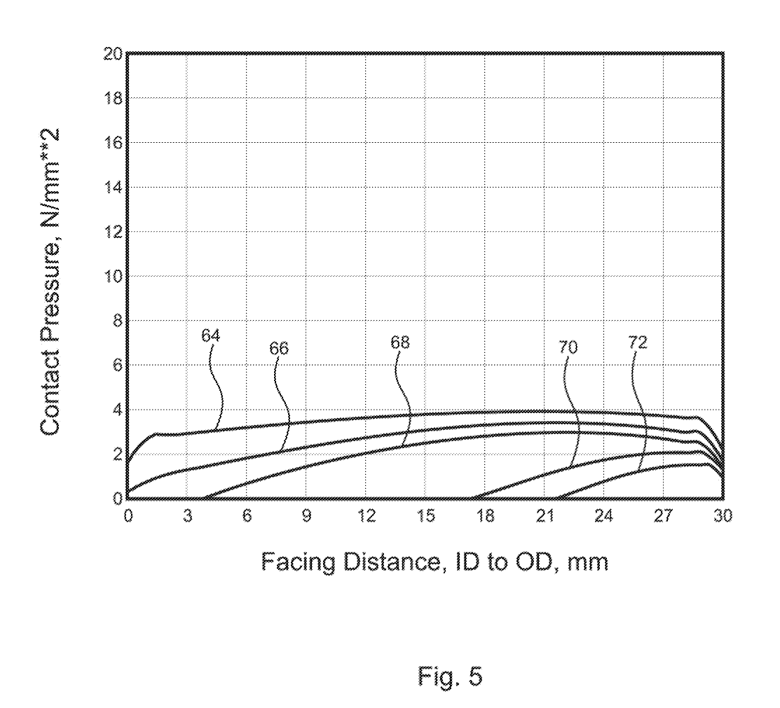

FIG. 5 is a graph similar to the graph of FIG. 4, in which the facing distance is plotted with respect to the contact pressure, but is plotted for a clutch arranged as depicted in FIG. 2, with the contact pressure measured in friction surface 35. Like in FIG. 4, lines 64, 66, 68, 70, and 72 relate respectively to pressures of 160 PSI, 120 PSI, 90 PSI, 30 PSI, and 15 PSI applied to the piston for closing the clutch. It can be seen that at higher apply pressures, the peaks seen in FIG. 4 have essentially been removed as a result of curving surface 44 slightly. Thus, this embodiment would result in a balanced unit loading across essentially the entirety of friction surface 35, even when the same pressures are applied to the piston for closing the clutch.

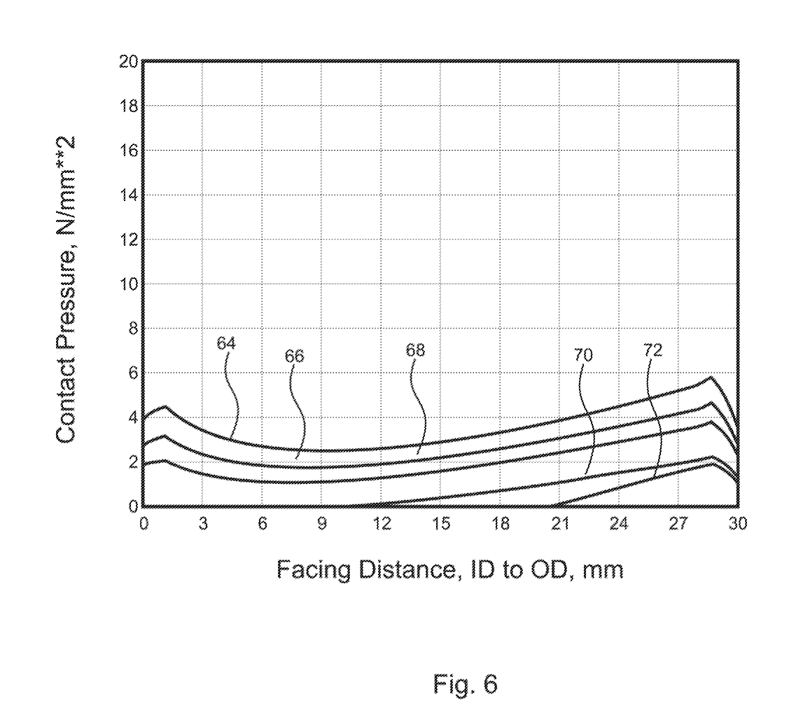

FIG. 6 is a graph similar to the graphs of FIGS. 4 and 5, in which the facing distance of friction surface 35 is plotted with respect to its contact pressure, but is plotted for a clutch arranged as depicted in FIG. 3. Like in FIGS. 4 and 5, lines 74, 76, 78, 80, and 82 relate respectively to pressures of 160 PSI, 120 PSI, 90 PSI, 30 PSI, and 15 PSI applied to the piston for closing the clutch. It can be seen that the peaks seen in FIG. 4 are still present, however, the contract pressure near the inner diameter has been significantly reduced. Thus, the embodiment of FIG. 3 could be used to lower pressure near the inner diameter.

Regardless of embodiment, member 28 is generally arranged to include a feature for making the member thinner at the portions of the member which are approximately radially aligned with the inner and/or outer diameters of the friction surfaces of the clutch, and thicker at the portion of the member that is located radially between the inner and outer diameters. As shown in FIG. 3, for example, it can be seen that the feature does not need to be exactly radially aligned with the inner or outer diameter, such as relief cut 48, which is radially outside of OD 38, but instead the thinner sections of member 28 should be located substantially or generally radially aligned with the inner and/or outer diameters. Thus, by “radially aligned” it is meant substantially or generally aligned, proximate, near, or adjacent. It should also be appreciated that only one relief cut need to be included, or the dome or bulge of surface 44 could be offset radially to some degree and does not need to be centered exactly at distance corresponding in the radial direction to the midpoint between the ID and OD. For example, it has been found that improved performance can result from placing the center of arc/radius R in FIG. 2 at a radial distance (with respect to the axis of rotation of the torque converter) greater than the radial distance of the midpoint between the ID and OD (again, measured in the radial direction with respect to the axis of the torque converter).

It should also be appreciated with respect to FIGS. 2 and 3, that a clutch according to the current invention need not be installed in a torque converter, although this is one application of the current invention. That is, piston 24 could be replaced with any engagement member for a clutch, and cover 12 generally replaced by any opposing member. Furthermore, while it is shown that three members are engaged (i.e., cover 12, piston 24, and plate 32), any other number of members could be coupled together according to the current invention, with each member including at least one friction surface. For example, piston 24 could engage directly with cover 12, with, for a further example, a piece of friction material bonded to either of the piston or the cover.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A clutch comprising:
a first member having a first friction surface, wherein said first friction surface has an inner diameter and an outer diameter;
a second member having a second friction surface;
wherein at least one of said first or second members is moveable axially for engaging said first friction surface with said second friction surface for closing said clutch;
wherein said first member is thinner in a first area approximately radially aligned with said first inner diameter, said first outer diameter, or both, than in a second area radially aligned with a portion of said first friction surface generally located radially between said first inner diameter and said first outer diameter.

2. The clutch recited in claim 1, wherein said first friction surface includes an axial bulge in said portion of said first friction surface between said first inner diameter and said first outer diameter.

3. The clutch recited in claim 2, wherein said axial bulge is defined by an arc having a radius at least one order of magnitude larger than a radial distance between said inner diameter and said outer diameter.

4. The clutch recited in claim 3, wherein said radius is approximately between 500 mm and 3000 mm.

5. The clutch recited in claim 3, wherein said radial distance between said inner and outer diameters of said first friction surface is between approximately 10 mm and 30 mm.

6. The clutch recited in claim 4, wherein said radial distance between said inner and outer diameters of said first friction surface is between approximately 10 mm and 30 mm.

7. The clutch recited in claim 6, wherein said radius has a value of approximately 2000 mm and said radial distance between said inner and outer diameters of said first friction surface is approximately 30 mm.

8. The clutch recited in claim 1, wherein said first member includes at least one relief cut located approximately radially aligned with said inner diameter, said outer diameter, or both, of said first friction surface.

9. The clutch recited in claim 8, wherein said at least one relief cut is formed in a second surface of said first member, said second surface being arranged axially opposite to said first friction surface.

10. A torque converter comprising the clutch recited in claim 1.

11. The torque converter recited in claim 10, further comprising a piston operatively arranged to move axially for engaging said clutch in response to a pressure applied to said piston.

12. The torque converter recited in claim 11, wherein said piston includes a tapered end for engaging said clutch.

13. The torque converter recited in claim 11, wherein said clutch is a lock-up clutch for mechanically connecting a vibration damper of said torque converter to a cover of said torque converter.

14. The torque converter recited in claim 13, wherein a plate from said vibration damper includes third and fourth friction surfaces for engaging said first and second friction surfaces of said first and second members, respectively.
